(19) United States
(12) Patent Application Publication
(10) Pub. No.: US 2014/0289280 A1
(43) Pub. Date: Sep. 25, 2014

(54) System and Method for Bi-directional Conversion of Directed Acyclic Graphs and Inter-File Branching

(71) Applicant: PERFORCE SOFTWARE, INC., Alameda, CA (US)

(72) Inventors: Geoffrey Z.A. Zichterman, Castro Valley, CA (US); Alan H. Teague, Alameda, CA (US)

(73) Assignee: PERFORCE SOFTWARE, INC., Alameda, CA (US)

(21) Appl. No.: 14/214,877

(22) Filed: Mar. 15, 2014

Related U.S. Application Data
(60) Provisional application No. 61/801,116, filed on Mar. 15, 2013.

(51) Int. Cl. G06F 17/30

(52) U.S. Cl. CPC G06F 17/30076; G06F 17/30958
USPC 707/797

(57) ABSTRACT

A system and methods for bi-directional conversion of directed acyclic graphs (DAG) and inter-file branching are described. The system for bi-directional conversion of directed acyclic graphs and inter-file branching includes memory, one or more processors, and one or more modules stored in memory. The one or more modules are configured for execution by the one or more processors. The modules include a conversion module configured to convert between a directed acyclic graph branch and an inter-file branch.

### CROSS-REFERENCE TO RELATED APPLICATION

This application claims the benefit of, and priority to, U.S. Provisional Patent Application Ser. No. 61/801,116, filed on Mar. 15, 2013, entitled “SYSTEM AND METHOD FOR BI-DIRECTIONAL CONVERSION OF DIRECTED ACYCLIC GRAPHS AND INTER-FILE BRANCHING,” by Geoffrey Z. A. Zichterman, et al., the entire disclosure of which is hereby incorporated in its entirety herein by reference.

### FIELD

Embodiments of the invention relate to directed acyclic graphs and inter-file branching. In particular, embodiments of the invention relate to a system and methods for conversion of directed acyclic graphs and inter-file branching.

### SUMMARY

A system and methods for bi-directional conversion of directed acyclic graphs (DAG) and inter-file branching are described. The system for bi-directional conversion of directed acyclic graphs and inter-file branching includes memory, one or more processors, and one or more modules stored in memory. The one or more modules are configured for execution by the one or more processors. The modules include a conversion module configured to convert between a directed acyclic graph branch and an inter-file branch.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements.

FIG. 1 illustrates lightweight branches in a branched workspace history for conversion according to an embodiment;

FIG. 2 illustrates the initial history cloned from a branched depot history generated according to an embodiment;

FIG. 3 illustrates assignment of branch identifiers to a branched workspace history according to an embodiment;

FIG. 4 illustrates arrangement of commits from a branched workspace history into a topological order to translate to a branched depot hierarchy according to an embodiment;

FIG. 5 illustrates arrangement of commits from a branched workspace history into a branch dev to translate to a branched depot hierarchy according to an embodiment;

FIG. 6 illustrates arrangement of commits from a branched workspace history into a branch task to translate to a branched depot hierarchy according to an embodiment;

FIG. 7 illustrates a branched workspace history based on an initial history cloned from a branched workspace hierarchy according to an embodiment;

FIG. 8 illustrates alternative branched depot hierarchies based on a branched workspace history including a lightweight branch according to an embodiment;

FIG. 9 illustrates a branched workspace history for converting to branched depot hierarchy according to an embodiment;

FIG. 10 illustrates a first potential branched depot hierarchy generated from a branched workspace history according to an embodiment;

FIG. 11 illustrates a second potential branched depot hierarchy generated from a branched workspace history according to an embodiment;

FIG. 12 illustrates a third potential branched depot hierarchy generated from a branched workspace history according to an embodiment;

FIG. 13 illustrates a branched workspace history that masks the source from which to populate a branch for a branched depot hierarchy according to an embodiment;

FIG. 14 illustrates alternative techniques to translate a branched workspace history into a branched depot hierarchy according to an embodiment;

FIG. 15 illustrates a block diagram of an embodiment of a system to associate information to a file according to an embodiment;

FIG. 16 illustrates a block diagram of a distributed system for bi-directional conversion of directed acyclic graphs (DAG) and inter-file branching according to an embodiment;

FIG. 17 illustrates an embodiment of system 602 that may be implemented as a client, server, a peer or other device that implements the methods according to the embodiment;

FIG. 18 illustrates a process for generating a branched depot hierarchy based on a branched workspace history according to an embodiment; and

FIG. 19 illustrates a process for generating a branched workspace history based on a branched depot hierarchy according to an embodiment.

### DETAILED DESCRIPTION

Embodiments of a system and methods for bi-directional conversion of directed acyclic graphs (DAG) and inter-file branching. Embodiments include converting directed acyclic graphs (also referred to herein as branched workspace histories) and inter-file branching (also referred to herein as branched depot hierarchies) between one or more formats. Examples used to illustrated systems and methods according to embodiments are described for converting between Git and Perforce formats.

An exemplary embodiment of a system that implements methods for bi-directional conversion of DAG and inter-file branching includes Git Fusion 13.1 by Perforce Software, Inc. Embodiments enable both Git and Perforce users to see the same branched history, the same merges between branches. Git users can now push branches and merge commits.

According to an embodiment, the system copies each Git commit to a Perforce changelist on an appropriate branch. The system creates anonymous Perforce branches to house commits whose “appropriate branch” has no name, which is often the case for task branches.

According to an embodiment, the system creates a lightweight branch for each branch that originates from Git. Lightweight branches hold branch and merge history from Git. Such a technique, minimizes the data cost in a non-Git based system, such as a Perforce based system.

In an embodiment, a merge in Git could be the equivalent to more than one command in another format. For example, a merge in Git may be the equivalent to any one of the commands in a Perforce format: integrate, merge, copy, and populate. Thus, the system is configured to choose the appropriate command. In the example of converting a Git merge into a Perforce format integrate is often used. In another example of converting a between formats, a Perforce pull is equivalent to any one the Git commands: git clone, pull, and fetch. In this example, one Perforce internal command covers all three Git commands. In yet another example, a Perforce branch is equivalent to a subset of a depot tree defined by a Perforce view. In an exemplary embodiment such as Git Fusion, Git Fusion does not use Perforce branch specs at all.

The system is configured to convert between differences from one revision control format to another. For example, Git branches are branches of workspace history. In contrast, Perforce branches are branches of depot hierarchy. Git lacks Perforce concepts such as depot hierarchy. Git has only one hierarchy, the work tree or, also known as, a workspace hierarchy. Another example of differences between Git and Perforce includes client view mapping. Since Git does not have a depot hierarchy, there is nothing to map. File actions are another area that Git and Perforce share differences. In contrast to Perforce, Git file actions are inferred by comparing Git commits. File integration history is also handled differently between Git and Perforce. In contrast to Perforce, Git has no per-file actions which makes it difficult to differentiate between edits and integrates in a Git merge commit. Thus, the system is configured to determine which branch is this commit. Further, Git commits do not record which branch was active at the time of commit. Anonymous branches are another difference between Git and Perforce. Git branch references can be deleted, or just not included with a git push. The result is that many sub-paths through Git commit history have no branch name causing anonymous branches.

Perforce lacks Git concepts such as commit hierarchy. Commit hierarchy in each Git commit has one or more parents. Another concept missing in Perforce includes branch references. Git branch references point to specific commits within the commit hierarch. Common history across branches is another Git concept not found in Perforce. Git history often shares the same sequence of commits across several branches. According to embodiments of the system, the system is configured to address differences when converting between different revision control formats.

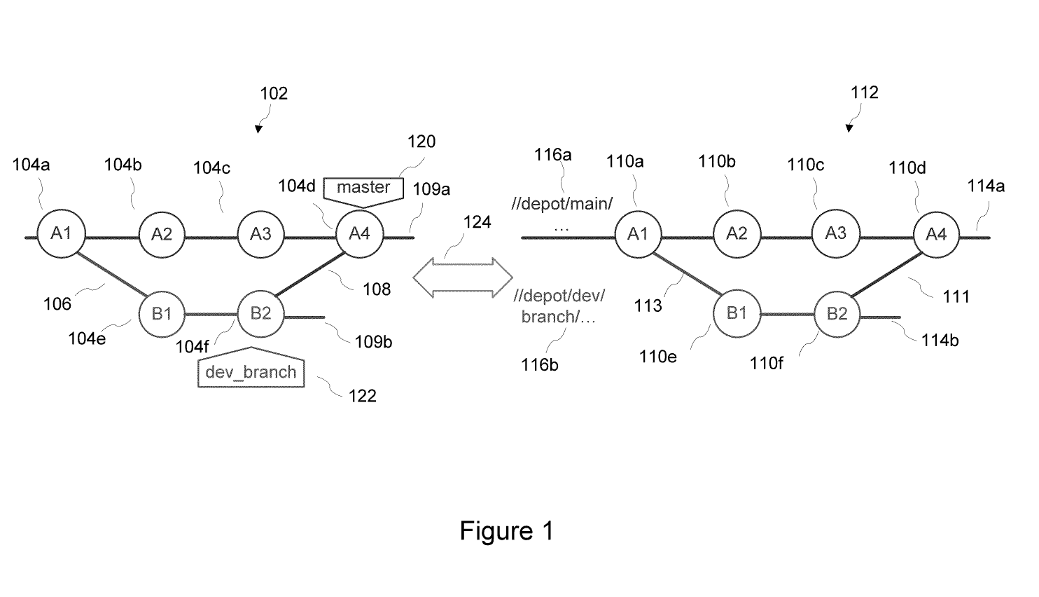

Lightweight branches, such as illustrated in FIG. 1, used in Git are described. Specifically, FIG. 1 illustrates a Git hierarchy or branched workspace history 102 of commits 104a-f which includes a workspace branch 106 and a workspace merge 108. The branched workspace history 102 also includes a master reference 120 and a dev_branch reference 122. Git users create many branches 109a-b. FIG. 1 also illustrates a Perforce collection of changelists 110a-f creating a branched depot hierarchy 112 including depot branches 114a-b generated by a translation process 124 according to embodiments, such as that used in Git Fusion. Creating branch and integrate records for a branched depot hierarchy 112 for every file in every branch of a workspace hierarchy 102 would crush the integrity of a database table. According to an embodiment to translate between Git and Perforce formats, the system is configured to create Perforce depot hierarchies 116 a-b that are populated only with files changed within that branch. These are the lightest impact on Perforce that still retains the branch 113 and merge 111 history between branches. The system is configured to permit merging from a lightweight branch into another branch, whether lightweight or not. This is common in branched workspace histories, such as Git, so most task branches in Git merge back into some ancestor branch.

Problems with lightweight branches such as those used in Git include: Git Fusion's lightweight branches are a specific solution to a specific Git Fusion requirement. Git Fusion creates no such client view. Perforce users who wish to work with a lightweight branch can merge that branch into a full Perforce branch and work there. Further, lightweight branches are not intended for Git Fusion administrators. Git Fusion administrators who wish to work in lightweight branches can push one from Git and let Git Fusion create the branch.

Anonymous branches may not be tracked in all systems including in Git. Git commits do not track which branch was active at time of commit. Git also permits commits with no branch active at all. A git push often transmits only one branch reference, omitting other branch names. The system, according to an embodiment, treats all such subsets of the Git commit hierarchy as anonymous. Further, the system stores anonymous branches just like any other Git branch: a lightweight branch. Thus, embodiments of the system to translate between different revision control formats are configured to address such differences when converting from one format, such as Git, to a second format, such as Perforce.

Examples of a Git push as implemented according an embodiment of the system includes:

A Git user . . .
1. Clones an existing branched depot hierarchy, such as a Git Fusion repo, which already defines a couple branches from Perforce.
2. Works on both branches in parallel.
3. Creates a small task branch to work on something else.
4. Merges between branches.
5. Pushes the whole thing back to the branched depot hierarchy.

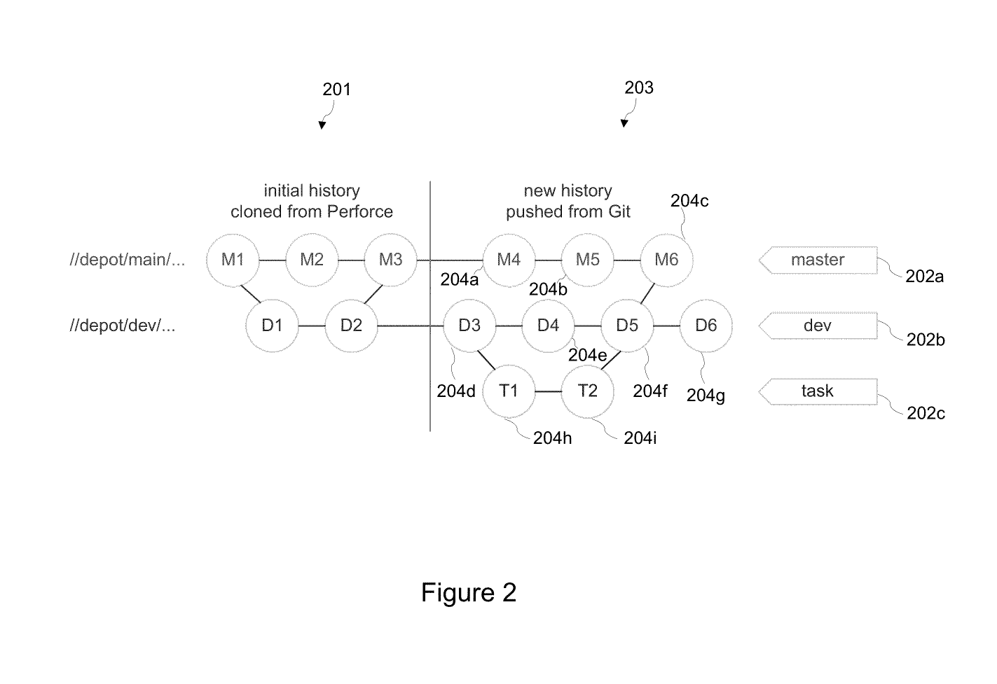

The example Git history looks like that illustrated in FIG. 2 which includes the initial history cloned 201 from a branched depot hierarchy 112, such as Perforce, and a new branched workspace history 203 pushed from Git. The system, according to an embodiment, receives a packfile containing all of the new commits 204a-i (including their trees and file contents), along with a list of branch references 202a-c that point into the new commits. If the Git user used git push—all, the system also receives a branch reference for a new branch task 202c. If not, the system still receives task's commits because they contribute to dev 202b, but does not receive the branch reference for task. Assuming a git push command is used—all sent three branch references: master 202a, dev 202b, and task 202c.

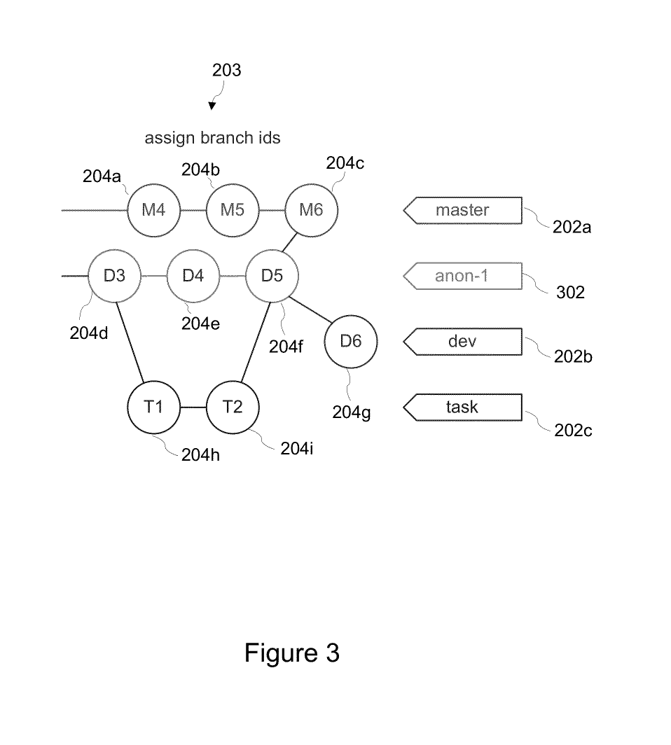

Referring to FIG. 3, the system is configured to calculating a branch identifier (ID) in Git. According to an embodiment, the system iterates over all the new commits 204a-i and determines to which branch(es) each commit belongs in the branched depot hierarchy as illustrated in FIG. 3. Merge commit D5 causes an ambiguous Git history and thus the system assigns D3-D4-D5 to an anonymous branch 302.

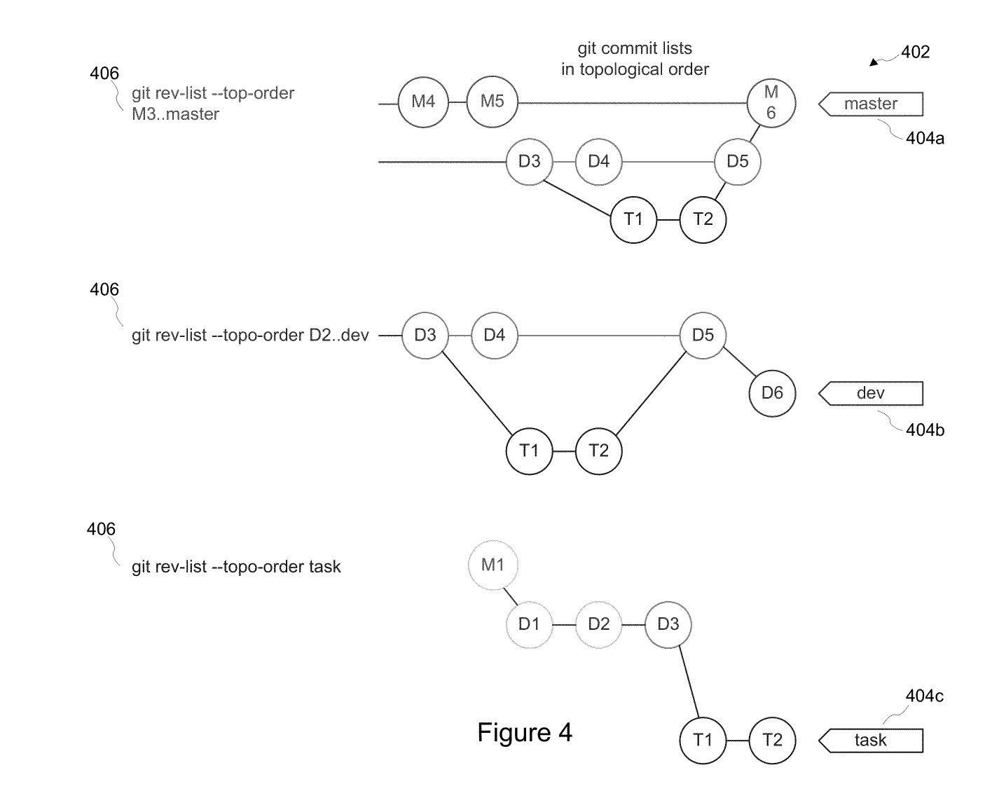

The system is configured to sort commits in topological order, group by branch. For each pushed branch reference 404a-404c, Git provides a list of new Git commits 402, in topological order, so that all descendant commits are listed before ancestor commits as illustrated in FIG. 4. A single pushed commit often appears in multiple pushed branches. As illustrated in FIG. 4, the task branch 404c lacks a starting commit for its git rev-list range 406, so Git provides history reaching far back to the beginning of time. The system, according to an embodiment, is configured to skip these older commits.

The system is configured to generate a master branch in the branched depot hierarchy based on the Git history. The system is configured to copy commits M4, M5 into the initial history cloned by Git. The system is configured to pick one pushed branch reference and start copying its commit history. According to an embodiment, the system starts with the master branch 404a because it appears near the top of the pictures, not because master is special anymore. For an example, the system copies commits M4 and M5 and their changes are applied to files in //depot/main/ . . . in two new changelists in the branched depot hierarchy.

The system is configured to copy commits D3, D4 in the branched depot hierarchy. For example, D3, as illustrated in FIG. 4, is assigned by the system to branch anon-1 in the branched depot hierarchy. Because a branch anon-1 does not yet exist, the system is configured to create this branch in the branched depot hierarchy.

According to an embodiment, the system is configured to create the branch anon-1 by generating a new branch identifier for the branch anon-1 in the branched depot hierarchy. For example, the commit D3 in Git has the identifier imXleytjFSEuCGWDT3eIUWw==. The system creates a new branch information file //.git-fusion/branch-info/mX/le/ytjFSEuCGWDT3eIUWw==. The system, according to an embodiment generates a file including the following:

```
            [mXleytjFSEuCGWDT3eIUWw==]
            root-depot-path = //.git-
fusion/branches/repo1/mX/le/ytjFSEuCGWDT3eIUWw==
            parent-branch-id = None
            parent-changelist = 1000
```

This file tells future processes by the system that there is (or is about to be) a lightweight branch stored at //.git-fusion/branches/repo1/mX/le/ytjFSEuCGWDT3eIUWw==/ . . . . In this example, it is a branch from a fully populated branch in the branched depot hierarchy, so it has no lightweight parent-branch-id. The system is configured to map this branch into the current branched depot hierarchy or repository (repo), adding it to the repo's lightweight branch configuration file, for example the file //.git-fusion/repos/repo1/p4gf_config2. As an example, this configuration file may contain the following:

[mXleytjFSEuCGWDT3eIUWw==]
view = //.git-

fusion/branches/repo1/mX/le/ytjFSEuCGWDT3eIUWw==/depot/dev/... ...

This p4gf_config2 entry provides no git-branch-name for this branch, since it is an anonymous branch. The system is configured to calculate a view for this branch by copying the view for branch dev 404b and inserting the branch root in front of the left-hand-side of each view line in the configuration file.

The system is configured to copy commit D3 using just-in-time branch actions. Continuing with the example as set out in FIG. 4, in Git commit D3 includes a modified file f. File f does not exist in branch anon-1's client location //client/f in the branched depot hierarchy which maps to depot location //.git-fusion/branches/repo1/mX/le/ytjFSEuCGWDT3eIUWw==/depot/dev/f. The system is configured to integrate the file into branch anon-1 before editing. The system is configured to iterate up the branch parent chain until it finds either a lightweight branch that holds that file, or a fully populated Perforce branch. As set out in the example, anon-1's parent-branch-id is None, which means the system hits a fully populated Perforce branch immediately. To populate from a fully populated Perforce branch, the system is configured to strip off the leading root-depot-path. In this example, the system strips off the leading root-depot-path //.git-fusion/branches/repo1/mX/le/ytjFSEuCGWDT3eIUWw== from destination depot path //.git-fusion/branches/repo1/mX/le/ytjFSEuCGWDT3eIUWw==/depot/dev/f path, resulting in //depot/dev/f. To calculate the correct file revision, the system is configured to look at commit D3's parent commit, D2. This commit has an object in //.git-fusion/objects/ . . . which identifies a corresponding Perforce changelist 1000. With a depot file and a changelist number, for such an example, the system can now integrate the correct file revision into the lightweight branch: p4 copy //depot/dev/f@1000.git-fusion/branches/repo1/mX/le/ytjFSEuCGWDT3eIUWw==/depot/dev/f.

With that file open for copy, the system re-opens that file for edit and applies D3's edits before submitting. By doing so, the system copies the file content from Git commit D3.

Once all file actions for commit D3 are copied into the current pending Perforce changelist, the system submits the changelist. The system is configured to copy a commit whose branch assignment differs from its parent (or no assigned branch in this case, or multiple parents in merge commits). For such a case, the system inserts lines in each Perforce changelist description to record this commit's immediate parent(s). An exemplary description record may contain the following:

Imported from Git:

parent-branch-id: None

parent-changelist: 1000

These lines help the system rebuild an exact Git history.

Continuing with the example in FIG. 4, a copy commit D4 by the system includes: Commit D4 edits file f again. Since that file already exists in branch anon-1, no just-in-time-branch is required. The system then edits the file in place and submits as described herein.

The system is configured to create branch task 404c in the branched depot hierarchy. The system uses a similar process as for creating the branch anon-1 as described above, except this time in the example we have a parent-branch-id as the system generated as previously describe above. In this example, Git generated a branch task for commit D4 of k7dYHjhKTCWjHSqWgEXZ8w==. The system generates a new branch identifier for the branched depot hierarchy based on the Git branch task. In this example, the system generates the new branch identifier //.git-fusion/branch-info/k7/dY/HjhKTCWjHSqWgEXZ8 w==. The system creates a new branch information file. For this example, the file includes the follow:

[k7dYHjhKTCWjHSqWgEXZ8w==]
root-depot-path = //.git-

fusion/branches/repo1/k7/dY/HjhKTCWjHSqWgEXZ8w==

parent-branch-id = mXleytjFSEuCGWDT3eIUWw==
parent-changelist = 2000

In this example the parent-branch-id points to the branch ID for anon-1, which is the branch assigned to T1's parent D3. Parent-changelist is the Perforce changelist number that corresponds to commit D3. The system is configured to map this branch into the current repo in the branched depot hierarchy. In this example the system adds an entry to //.git-fusion/repos/repo1/p4gf_config2. For an example, the entry includes:

[k7dYHjhKTCWjHSqWgEXZ8w==]
git-branch-name = task
view = //.git-

fusion/branches/repo1/k7/dY/HjhKTCWjHSqWgEXZ8w==/depot/dev/...
...

Continuing with the example as illustrated in FIG. 4, the system copies commit T1. The system performs just-in-time branch action the copy, because in this example commit T1 modifies file g. File g does not exist in branch task's client location //client/g which maps to depot location //.git-fusion/branches/repo1/k7/dY/HjhKTCWjHSqWgEXZ8 w==/depot/dev/g. The system iterates up the branch parent chain until it finds the file or a fully populated Perforce using techniques as described here. Parent mXleytjFSEuCGWDT3eIUWw==(aka anon-1) has no file g. Next parent is a fully populated Perforce branch. The system is configured to integrate the file from //depot/dev/g using techniques as described above with respect to integrating file f in commit D3. The system appends the changelist description. An exemplary changelist description may be appended to include the following:

Imported from Git:

parent-branch-id: mXleytjFSEuCGWDT3eIUWw==

parent-changelist: 2000

According to an embodiment, the system records the parent-branch-id and parent-changelist of the immediate parent commit, even though the file was integrated from a more distant ancestor. For such an embodiment, the system may use this information to rebuild history later.

Continuing with the example illustrated in FIG. 4, the system is configured to copy commit T2 from the branched workspace history into the branched depot hierarchy. For this example, the commit T2 edits file g again, thus the system copies commit T2 as a normal edit using techniques as described herein.

For commit D5 as illustrated in FIG. 4, the system is configured to copy commit D5 from the branched workspace history into the branched depot hierarchy. As previously described, the system assigned commit D5 to branch anon-1, which the system created as described herein. The system switches that branch's view. Commit D5 is a merge commit, that is, a commit with 2 or more parent commits. For each file in commit D5, if that file's contents differ from the destination branch, the system is configured to integrate the file's contents from one or more contributing branches. For this example, file f in D5 is identical to its contents in D4, the system does not need to integrate this file. For this example, file g in D5 does not exist in the destination branch anon-1, file g has contents identical to commit T2 in the branch task 404c. The system integrates file g from branch task 404c to branch anon-1 in the branched depot hierarchy. The system maps client path g to //.git-fusion/branches/repo1/k7/dY/HjhKTCWjHSqWgEXZ8 w==/depot/dev/g for contributing branch task, and //.git-fusion/branches/repo1/mX/le/ytjFSEuCGWDT3eIUWw==/depot/dev/g for destination branch anon-1. The system appends the changelist description. For example, the system appends the changelist description to include:

Imported from Git:

parent-branch-id: mXleytjFSEuCGWDT3eIUWw==

parent-changelist: 2001

parent-2-branch-id: k7dYHjhKTCWjHSqWgEXZ8w==

parent-2-changelist: 2003

Referring to the commit M6 illustrated in FIG. 4, the system copies commit M6 from the branched workspace history to the branched depot hierarchy. As described above, the system assigned Commit M6 to branch master 404a. The system switches to that branch's view. Commit M6 is a merge commit. For each file in commit M6, if that file's contents differ from the destination branch, the system integrates it from one or more contributing branches. For this example, files f and g in M6 differ from their contents in M5, but match their contents from contributing commit D5. The system integrates files f and g from contributing commit D5 into M5. To do this, the system maps client path f to //.git-fusion/branches/repo1/mX/le/ytjFSEuCGWDT3eIUWw==/depot/dev/f/ for contributing branch anon-1, and //depot/dev/f for destination branch master. The system performs a similar mapping for file g. The system appends the changelist description. For example, the system appends to the changelist description to include:

Imported from Git:

parent-branch-id: None

parent-changelist: 1999

parent-2-branch-id: mXleytjFSEuCGWDT3eIUWw==

parent-2-changelist: 2004

The system has converted all of the commits from the branched workspace history to in branch master 404a to the branched depot hierarchy.

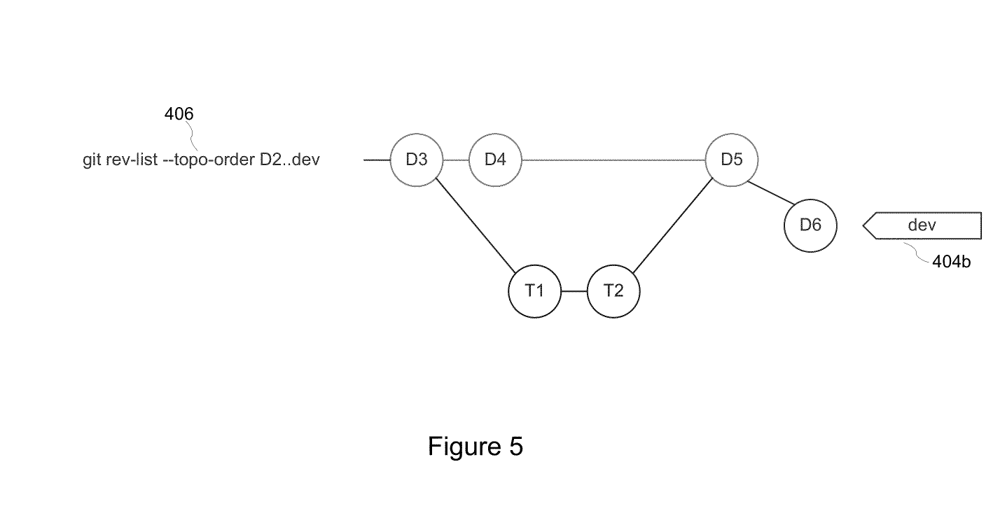

Continuing with the example, the system converts the next branch from the branched workspace history, the branch dev 404b, to the branched depot hierarchy. The system starts the whole process over again for another branch, the branch dev 404b as illustrated in FIG. 5. The system skips over the commits it already copied to the branched depot hierarchy converted from the branch master 404a as described above. In FIG. 5, the only new commit here is D6, assigned to fully populated branch dev 404b. The system switches to the view for branch dev. The system assigned parent commit D5 to a different branch as described above, so the system copies between branches to bring this branch up to date. The system integrates files in commit D5 using techniques such as those described herein. The system then applies commit D6.

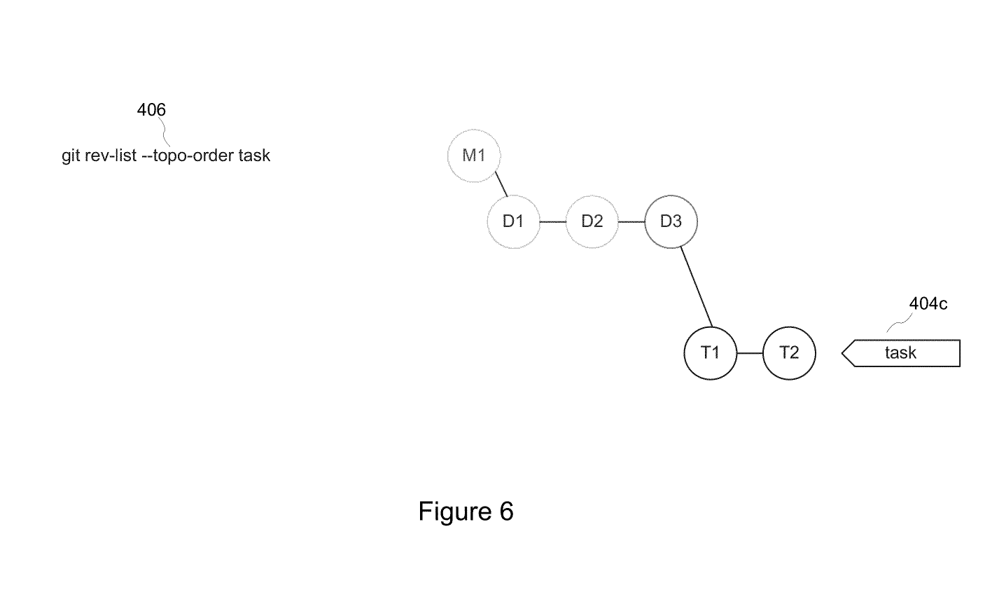

In the example, the system has the branch task left to convert from the branched workspace history to the branched depot hierarchy. For the example, the system starts the whole process over again for another branch, branch task 404c as illustrated in FIG. 6. The system skips over the commits it already copied from the branched workspace history to the branched depot hierarchy as described above. In this example, no more commits need to be processed by the system.

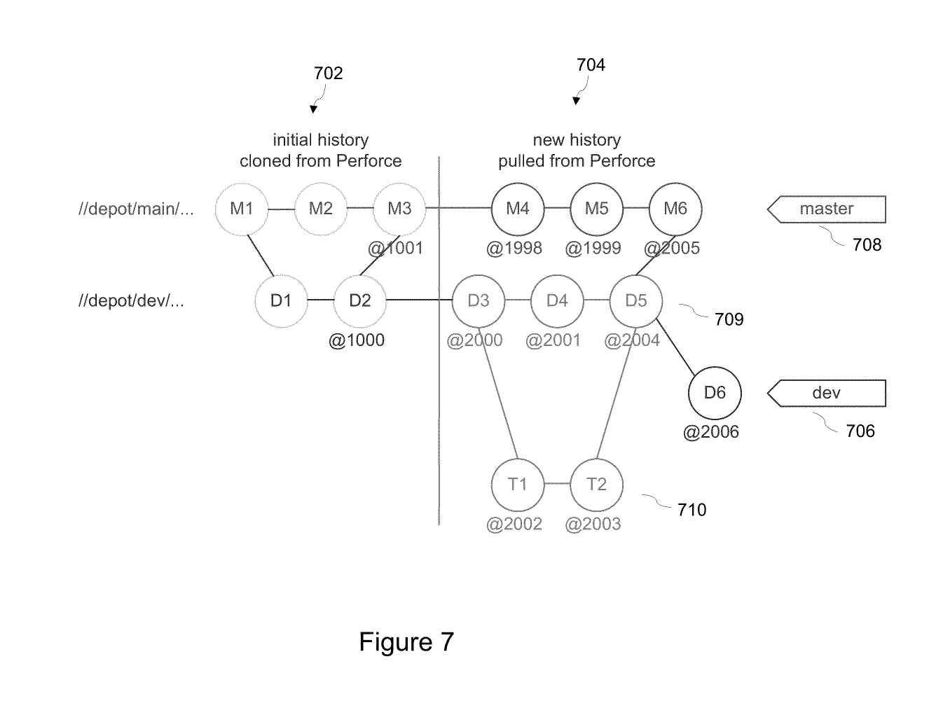

In an example illustrating how the system handles a Git pull, a second repository in the system contains the same two branch definitions for master and dev, has the same initial history 702 cloned from the branched depot hierarchy, such as Perforce. A second Git user runs git pullthrough that second repository of the system to copy all of the new history 704, the new history 704 generated by the system as described above, and illustrated in FIG. 7.

In this example, the system collects a list of all branches. To do this, the system identifies the branches based on entries in the second repository's configuration files. As an example the configuration files below includes the following entries in the two configuration files:

//.git-fusion/repos/repo2/p4gf_config
[master]
git-branch-name = master
view = //depot/main/... ...
[dev]
git-branch-name = dev
view = //depot/dev/... ...
//.git-fusion/repos/repo2/p4gf_config2
<empty>

Continuing the example, the system is configured to fetch the new changelists to generate file revisions. For each branch that has a value for git-branch-name, the system checks to see if there are any new changelists in that branch's view that have not yet been copied to the system repository. The system is configured to fetch the Git commit SHA-1 that corresponds to the branch's git-branch-name, then look up that commit in //.git-fusion/objects/ . . . , find the Perforce changelist number nnnn that corresponds to this repository for this branch. The system switches to that branch's view. For an embodiment such as Git Fusion, the system performs a Run p4 print-ak //client/ . . . @nnnn,#head to fetch all new file revisions.

A side effect of p4 print is that the system learns the changelist numbers that go with each file revision, so the system also builds a list of changelist numbers to copy to Git. Another side effect of p4 print is that the system learns the file action. For the majority of Perforce file actions, there is no integration going on, so we can usually bypass the expensive process of calculating merge history. For this example and according to an embodiment, the system retrieves the following changelists for the new history 704 illustrated in FIG. 7 which includes branch master 708 and branch dev 706:

@1998 //depot/main/x#5 edit
@1999 //depot/main/x#6 edit
@2005 //depot/main/f#3 integ <-- changelist 2005 is a merge commit
@2005 //depot/main/g#3 integ
@2006 //depot/dev/f#3 integ <-- changelist 2006 is a merge commit
@2006 //depot/dev/g#3 integ
@2006 //depot/dev/y#3 edit

Continuing with the example, the changelists for D3/@2000, D4/@2001, and D5/@2004 as well as T1/@2002 and T2/@2003 are missing from the list above. These changelists occurred outside our two named branches. D3-D4-D5 are on an anonymous branch (anon), and T1-T2 are on a branch that has a name and a Git branch reference in repository 1 but not in our current repository 2, thus anonymous to repository 2. For this example, the system does not yet see those changelists or their file revisions.

The system is configured to follow integration sources. If we have one or more integration actions, the system can access a filelog, such as p4 filelog, to learn integration from where. Integration from outside the destination branch requires a Git merge commit. Integration from outside all known branch views requires a new branch view. From a file log, such as a p4 filelog, the system determines more about the changelists and branches. For this example, the system now had the follow information regarding the changelist and the branches:

@2000 //.git-
fusion/branches/repo1/mX/le/ytjFSEuCGWDT3eIUWw==/depot/dev/f#1
integ+edit from
//depot/dev/f#1
@2001 //.git-
fusion/branches/repo1/mX/le/ytjFSEuCGWDT3eIUWw==/depot/dev/f#2 edit
@2002 //.git-
fusion/branches/repo1/k7/dY/HjhKTCWjHSqWgEXZ8w==/depot/dev/g#1
integ+edit from
//depot/dev/g#1
@2003 //.git-
fusion/branches/repo1/k7/dY/HjhKTCWjHSqWgEXZ8w==/depot/dev/g#2 edit
@2004 //.git-
fusion/branches/repo1/mX/le/ytjFSEuCGWDT3eIUWw==/depot/dev/g#1 copy
from
//.git-fusion/branches/repo1/k7/dY/HjhKTCWjHSqWgEXZ8w==/depot/dev/g#2
@2005 //depot/main/f#3 integ from

//.git-fusion/branches/repo1/mX/le/ytjFSEuCGWDT3eIUWw==/depot/dev/f#2

@2005 //depot/main/g#3 integ from

//.git-fusion/branches/repo1/mX/le/ytjFSEuCGWDT3eIUWw==/depot/dev/g#1

@2006 //depot/dev/f#3 integ from
//.git-fusion/branches/repo1/k7/dY/HjhKTCWjHSqWgEXZ8w==/depot/dev/f#2
@2006 //depot/dev/g#3 integ from

//.git-fusion/branches/repo1/mX/le/ytjFSEuCGWDT3eIUWw==/depot/dev/g#1

The system is configured to follow changelist description data. For an embodiment, Run p4 changes to fetch changelist descriptions. The system needs any parent-branch-id values that previous processes of the system added to the changelist descriptions.

The system is configured to match integration sources to lightweight branches. Continuing with the above example, the system is configured to read all branch information files. For example, the system is configured to reach all branch information form files at the location //.git-fusion/branch-info/ . . . . For such an example, the system may access the following files that include the information below:

//.git-fusion/branches/repo1/mX/le/ytjFSEuCGWDT3eIUWw==
[mXleytjFSEuCGWDT3eIUWw==]
root-depot-path = //.git-
fusion/branches/repo1/mX/le/ytjFSEuCGWDT3eIUWw==
parent-branch-id = None
parent-changelist= None
//.git-fusion/branch-info/k7/dY/HjhKTCWjHSqWgEXZ8w==
[k7dYHjhKTCWjHSqWgEXZ8w==]
root-depot-path = //.git-
fusion/branches/repo1/k7/dY/HjhKTCWjHSqWgEXZ8w==
parent-branch-id = mXleytjFSEuCGWDT3eIUWw==
parent-changelist= 2000

For each integration source that comes from a lightweight branch, the system is configured to add that lightweight branch to this repository (if not already added). For each changelist description parent-branch-id that is not already in this repository, the system is configured to add it. Each integration source that comes from no known lightweight branch and no branch is already defined, the system is configured to demote to add/edit/delete.

In this example, both lightweight branches k7dYHjhKTCWjHSqWgEXZ8w== and mXleytjFSEuCGWDT3eIUWw==hold integration sources, and neither is yet listed in repository's 2 list of lightweight branches. The system, in the example, adds them now. The system may add the branches as:

//.git-fusion/repos/repo2/p4gf_config2
[k7dYHjhKTCWjHSqWgEXZ8w==]
view = //.git-
fusion/branches/repo1/k7/dY/HjhKTCWjHSqWgEXZ8w==/depot/dev/...
...
[mXleytjFSEuCGWDT3eIUWw==]
view = //.git-
fusion/branches/repo1/mX/le/ytjFSEuCGWDT3eIUWw==/depot/dev/...
...

A file log, such as a p4 filelog, showed that each of these two branches integrated from paths that intersect known branch dev's view //depot/dev/ . . . , so the system uses dev's view as the basis for mapping these anonymous lightweight branches into repository 2.

The system is configured to fetch new changelists and file revisions. For each lightweight branch that we just added, the system switches to that branch's view. For a Git Fusion embodiment, the system performs Run p4 print-ak //client/ . . . @nnnn,#head to fetch all new file revisions using techniques similar to those described above. From this print the system gets content for file revisions, and learns actions that the system already determined based on the earlier p4 filelog:

@2000 //.git-
fusion/branches/repo1/mX/le/ytjFSEuCGWDT3eIUWw==/depot/dev/f#1
integ+edit from //depot/dev/f#1
@2001 //.git-
fusion/branches/repo1/mX/le/ytjFSEuCGWDT3eIUWw==/depot/dev/f#2
edit
@2002 //.git-
fusion/branches/repo1/k7/dY/HjhKTCWjHSqWgEXZ8w==/depot/dev/g#1
integ+edit from //depot/dev/g#1
@2003 //.git-
fusion/branches/repo1/k7/dY/HjhKTCWjHSqWgEXZ8w==/depot/dev/g#2
edit
@2004 //.git-
fusion/branches/repo1/mX/le/ytjFSEuCGWDT3eIUWw==/depot/dev/g#1
copy
from
//.git-
fusion/branches/repo1/k7/dY/HjhKTCWjHSqWgEXZ8w==/depot/dev/g#2

Each of these integration sources are known branches. The system stops looping on p4 print and p4 filelog.

The system is configured to translate changelists to commits. To do this, the system sorts the list of changelists by changelist number, and copies them to Git via git-fast-import. For this example, the system translates changes 1998, 1999 to master. To do this, the system switches client view to that of branch master. The system copies file actions to Git. The system translates changes 2000, 2001 to anon-1 709. To do this, the system switches client view to that of branch anon-1 709 (mXleytjFSEuCGWDT3eIUW==). In this example, change 2000 contains integration actions from known, fully-populated branch dev 706 to current branch anon-1 709. For this example, the changelist description contains:

Imported from Git:

parent-branch-id: None

parent-changelist: 1000

In this example, changelist 1000 corresponds to Git commit D2 for repository 2, branch dev 706. The system sets that as the Git parent commit for this commit D3/@2000. The system copies file actions to Git. The system translates change 2002, 2003 to anon-2 710. The system switches client view to that of branch anon-2 710 (k7dYHjhKTCWjHSqWgEXZ8w==). In this example change 2002 contains integration actions from branch dev 706 to current branch anon-2 710. The changelist description contains:

Imported from Git:

parent-branch-id: mXleytjFSEuCGWDT3eIUWw==

parent-changelist: 2000

Notice that for this example the branched depot hierarchy, such as Perforce, file integration comes from branch dev 706 (the system directly just-in-time-branched a file from a distant ancestor into this lightweight-branch-of-a-branch). The system overrides dev in this example in favor of mXleytjFSEuCGWDT3eIUWw==specified in the changelist description.

In this example, changelist 2000 in branch mXleytjFSEuCGWDT3eIUWw==corresponds to Git commit D3/@2000 which the system copied earlier. The system, in this example, uses that as the parent commit for this commit T1/@2002. In this example, because changelist T2/2003 is a simple edit, the system copies it using techniques described herein.

The system is configured to translate change 2004 to anon-1 709. Change 2004 is a merge commit from two lightweight branches. Its changelist description for this example contains:

Imported from Git:

parent-branch-id: mXleytjFSEuCGWDT3eIUWw==

parent-changelist: 2001

parent-2-branch-id: k7dYHjhKTCWjHSqWgEXZ8w==

parent-2-changelist: 2003

Those changelists correspond to commits the system copied to Git. The system uses those commits as parents.

If this were a merge created solely in Perforce, thus one whose changelist description lacked parent information, Git Fusion would follow integration history with p4 filelog and use that to find parent-branch-id and parent-changelist.

Continuing with the example, the system translates change 2005 to branch master 708. Change 2005 is a merge commit from a lightweight branch into a fully populated branch. The system in this example appends to the changelist description:

Imported from Git:

parent-branch-id: None

parent-changelist: 1999

parent-2-branch-id: mXleytjFSEuCGWDT3eIUWw==

parent-2-changelist: 2004

Continuation with the example, the system translates change 2006 in the branched depot hierarchy to branch dev 706 in the branched workspace history using techniques described herein.

The system is configured to update branch references in the branched workspace history. At this point in the example, the system has copied commits (and their trees and file content blobs) into the branched workspace history, such as Git. The system now forces each branch reference to point the head commit. For example, the system uses the git command:

git branch-f master M6 git branch-f def D6

Git Fusion does not create a branch reference for a task in repository 2: that branch reference was pushed to repository 1 and the system does not copy new branch references between repositories. For an embodiment, the system can be configured to have a branch reference to appear in multiple repositories can add a git-branch-name value to the appropriate branch definition in a configuration file, such as p4gf_config2.

The system is configured to generate use data for the translation from a branched workspace history to a branched depot hierarchy and vice versa. Such data used by the system includes a lightweight branch info file. Each lightweight branch has an info file, for example an info file at //.git-fusion/branch-info/{branch-id}:

//.git-fusion/branch-info/mX/le/ytjFSEuCGWDT3eIUWw==:
[mXleytjFSEuCGWDT3eIUWw==]
root-depot-path = //.git-
fusion/branches/repo1/mX/le/ytjFSEuCGWDT3eIUWw==
parent-branch-id = None
parent-changelist= 1000

For an embodiment, root-depot-path is a depot path that contains this branch's versioned files. Parent-branch-id is the immediate ancestor of this branch. For children of fully populated branches, this is None. For an embodiment, parent-changelist is the Perforce changelist number that corresponds to whatever Git commit was the parent of the first Git commit in this lightweight branch.

It is possible for a lightweight branch to have multiple parents. Such branches appear when the first commit on a Git branch is a merge commit. Git users rarely create such a thing, but anonymous branch boundaries make such a commit likely. Multiple parents and their corresponding changelists are listed by inserting a number (2 or greater), for example:

[mXleytjFSEuCGWDT3eIUWw==]
root-depot-path = //.git-
fusion/branches/repo1/mX/le/ytjFSEuCGWDT3eIUWw==
parent-branch-id = None
parent-changelist= 1000
parent-2-branch-id = 16JrStD2T9eF8UllrZJxjA==
parent-2-changelist= 2112

It is possible for a lightweight branch to have zero parents. Zero parents omit parent-branch-id and parent-changelist. See repo config2 for how this lightweight branch maps into one or more Git Fusion repos.

root-depot-path makes it possible that the branch's versioned files will live somewhere other than //.git-fusion/branches/{repo}/{branch-id}/ . . . . Embodiments of a system will permit control as to where the system stores versioned files. In some embodiments, path to branch info files is hardcoded, and are not configurable.

The system is configured to translate between lightweight branches of branched workspace histories to versioned files of branched depot hierarchies. The system, according to an embodiment, creates a hierarchy under a branch root that mimics the hierarchy under // . . . . This makes it trivial to translate between the branched depot hierarchies, such as “normal” Perforce depot paths, such as //depot/main/f and the lightweight branch's copy of the same file at //.git-fusion/branches/repo1/mX/le/ytjFSEuCGWDT3eIUWw==/depot/main/f.

Repo Config: Fully Populated Branches

For an embodiment, lightweight branches do not appear in a configuration file, such as p4gf_config. For such an embodiment, any branch listed in this file is assumed to be fully populated. Listing a lightweight branch in this file will create a strange and sparsely populated Git repository, with a metric hatload of missing files in each Git Commit.

Repo Config2: Lightweight Branches

For an embodiment, configuration files, such as p4gf_config2, maps zero or more lightweight branches into this repository of the system. These branches can be anonymous, or have a name (and thus a Git branch reference) associated with them, for example:

[mXleytjFSEuCGWDT3eIUWw==]
view = //.git-
fusion/branches/repo1/mX/le/ytjFSEuCGWDT3eIUWw==/depot/dev/... ...
[k7dYHjhKTCWjHSqWgEXZ8w==]
git-branch-name = task
view = //.git-
fusion/branches/repo1/k7/dY/HjhKTCWjHSqWgEXZ8w==/depot/dev/...
...

The system, for an embodiment, may omit anonymous branches from this file. The system is configured to detect and map them into a repository when necessary. Saves on clutter in a configuration file, such as p4gf_config, reduces the number of branches that the system queries on every git pull and locks during git push. With no Git references pointing to an anonymous branch, that branch will never grow another commit.

Changelist Descriptions

The system inserts parent branch and commit information so that it can rebuild Git history later. An example of commit information includes:

Imported from Git:

parent-branch-id: None

parent-changelist: 1999

Parent information may be omitted if child and parent are both on the same branch. Merge commits, for an embodiment, always list every parent, including parent from the current branch, for example:

Imported from Git:

parent-branch-id: mXleytjFSEuCGWDT3eIUWw==

parent-changelist: 2001

parent-2-branch-id: k7dYHjhKTCWjHSqWgEXZ8w==

parent-2-changelist: 2003

The system for an embodiment tracks file integration history. In addition, embodiments include information to track a lightweight branch child of a lightweight branch parent just-in-time-branch a file directly from a fully-populated grandparent branch, bypassing the immediate parent. This gives the system the ability to rebuild history. When this information is absent to rebuild histories, embodiments of the system are configured to use file integration history to calculate parents. Such information is an artifact of lightweight branching which cannot be created in some branched depot hierarchies, such as some versions of Perforce.

For an embodiment, the system splits each lightweight branch into two parts:

1. A branch of branched depot hierarchy of versioned files

2. Map that branched depot hierarchy into Git

This split allows a single lightweight branch to be shared across multiple repositories, also survive a repository refactor. This split allows the system, according to an embodiment, to keep each repository's branch namespace isolated from other repositories.

According to an embodiment, the system stores all branch info files, repo config files, and changelist descriptions in a server, such as Perforce, as UTF-8. For an embodiment, metadata used by the system are versioned, changelist specs are partially versioned, and counters are not versioned at all.

The system, according to an embodiment, is configured to use unique branch identifiers. For example, {branch-id} is a unique identifier that the system generates for each anonymous branch. It must be unique across all branches, all repositories for some embodiments. It cannot be a commit SHA1 (commits can be shared across branches and repos). It could be a counter, although that has a performance cost.

For an embodiment, the system generates a 128-bit global unique identifier (GUID) for a unique branch identifier. Such an GUID may be represented as a 24-character base64 encoded string, for example:

RmYw29B0TUq27V11ZQ2eVQ==

(aka 466630DB-D074-4D4A-B6ED-5D75650D9E55)

Other embodiments include using 37-character hexadecimal encoded strings.

For an embodiment, the system avoids creating a single depot hierarchy container with thousands of children because depot navigation tools may become unusable Such an embodiment may break up the branch identifier list. For example, the system is configured to break up the top layers by two characters each, just like we do for Git SHA-1s:

//.git-fusion/branches/Rm/Yw/29B0TUq27V11ZQ2eVQ==
//.git-fusion/branches/OU/WX/aI+BRNaixzescoTj1Q==

This limits the top two directories to 642=4096 entries each.

For an embodiment, the system is configured to use a 1:N branch mapping identifier. The branch-id that appears in a repository's branch mapping (such as in p4gf-config2), according to an embodiment, does not have to match the branch-id of the depot hierarchy that the branch mapping lists. It is expected that a single lightweight branch of depot hierarchy such as //.git-fusion/branches/repo1/mX/le/ytjFSEuCGWDT3eIUWw==/ . . . could be mapped into a repo as multiple lightweight branches. This could occur if one repo has multiple fully populated branches, each intersecting a single fully populated branch that a second repo uses, for example:

Repo1:
[master]
//depot/main/... ...
[mXleytjFSEuCGWDT3eIUWw==]
//.git-fusion/branches/repo1/mX/le/ytjFSEuCGWDT3eIUWw==/depot/main/...
...

With files in two directories: depot/main/src/... src/... depot/main/lib/... lib/...

Repo2
[source]
//depot/main/src/... ...
[libraries]
//depot/main/lib/... ...
[mXleytjFSEuCGWDT3eIUWw==-source]
//.git-
fusion/branches/repo1/mX/le/ytjFSEuCGWDT3eIUWw==/depot/main/src/... ...
[mXleytjFSEuCGWDT3eIUWw==-libraries]
//.git-
fusion/branches/repo1/mX/le/ytjFSEuCGWDT3eIUWw==/depot/main/lib/... ...

Such oddly mapped Git repos are annoying: switching between such unrelated branches swaps the entire world out from under you. But they do exist: for example the Git project itself did something like this (one branch for source, one for documentation) and eventually abandoned it.

The system, according to an embodiment, may combine depot branch-id strings with mapping ID strings to produce branch mapping ID strings for a single lightweight branch's view(s) into a repo. An alternative embodiment includes a system that may generate new GUIDs for each branch mapping ID.

A task stream does not reduce the data cost of a branch: it moves the data to a separate store. A task stream reduces data when it is deleted/unloaded/archived. For any long-lived Git branch, data is never reduced. For an embodiment, the system if configured to use task streams. For example, some embodiments support P4D 11.1+.

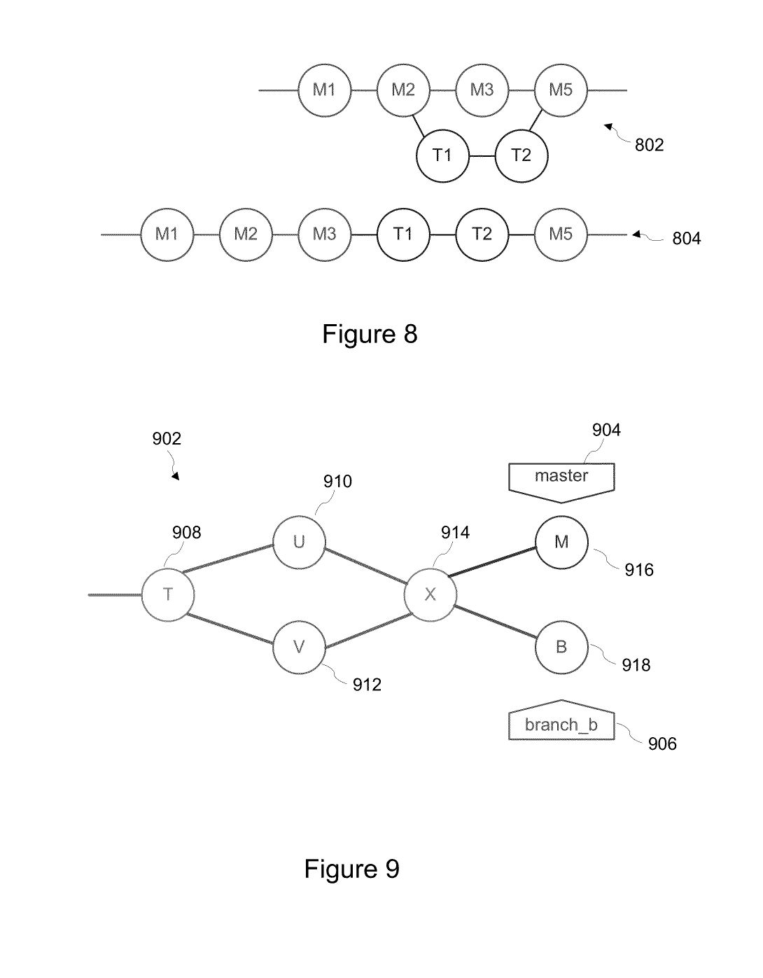

Now referring to FIG. 8. For an embodiment, instead of creating a branched depot hierarchy including a lightweight branch 802 to hold a few revisions of a few files, the system is configured to put those few revisions directly on the original branch 804. For such an embodiment, the system is configured to store a little extra metadata in each changelist description identifying the branch and Git commit parents so that we can rebuild the Git commit history again later. Such an embodiment reduces the number of branches in the branched depot hierarchy. For an embodiment, the system changes file descriptions of the changes on this file, including any branches twined into the file. For such an embodiment, no integ table is required.

Such system may include time lapse view that has jarring shifts when jumping from one branch to another. Branches that continue on without merging into the parent would leave the parent in an incorrect state. Submitting a “restore parent” changelist to can be used to bring things back. For an embodiment, the feature adds some and removes no code from the system. Such a system can still can follow branch and merge chains through normal Perforce branches and named Git Fusion branches.

For an embodiment, the system integrates all of the files that exist in a lightweight parent into a lightweight child at time of lightweight child branch creation. For some embodiments, this optimization does not apply to lightweight child branches of fully populated parent branches: that would fully populate the child.

This implies that each lightweight child branch will have at least as many files already integrated into it as its lightweight parent, but usually far fewer than a fully populated branch. This optimization removes a need to teach the system how to search integration history for unintegrated changes in ancestor branches. The cost is a greater load on the integ table, but usually much less and never worse than a fully populated branch.

An alternative to the process described in the example above includes before copying file g into commit T1, the system, according to an embodiment, would first integrate file f, since it exists in parent branch anon-1, for example:

p4 copy //.git-
fusion/branches/repo1/mX/le/ytjFSEuCGWDT3eIUWw==/depot/dev/f@2000
//.git-fusion/branches/repo1/k7/dY/HjhKTCWjHSqWgEXZ8w==/depot/dev/f

Now the Perforce files in lightweight branch task contain a complete integration history of all files D3-T1-T2. If a Git Author were to merge T2 into master or some other branch, Git Fusion would correctly copy all files' integration history.

For an embodiment, git push feeds the system all the files needed via git-fast-export, which all go into the current branch. No point in overlaying the current branch over ancestors since we′re not reading or writing to those ancestors. Further, git pull gets all its files from p4 changes (and friends). Again, no overlay needed.

Git does not store enough information to correctly associate each commit with a single branch. This is not a concept that Git requires or tracks. But Perforce does require a branch for each commit, as the branch determines which branch of depot hierarchy houses the changelist. In such cases, the system, according to an embodiment, can only guarantee that the most recent commit of each pushed branch, also known as each pushed branch reference head, is on the correct Perforce branch of depot hierarchy.

For an embodiment, each non-head commits goes on a branch of indeterminate correctness, with no guarantee. Task branch commits might end up on mainline. Long strings of mainline commits might end up in some anonymous task branch. It's all a big guess until the end, when things line up again and we get a correct result.

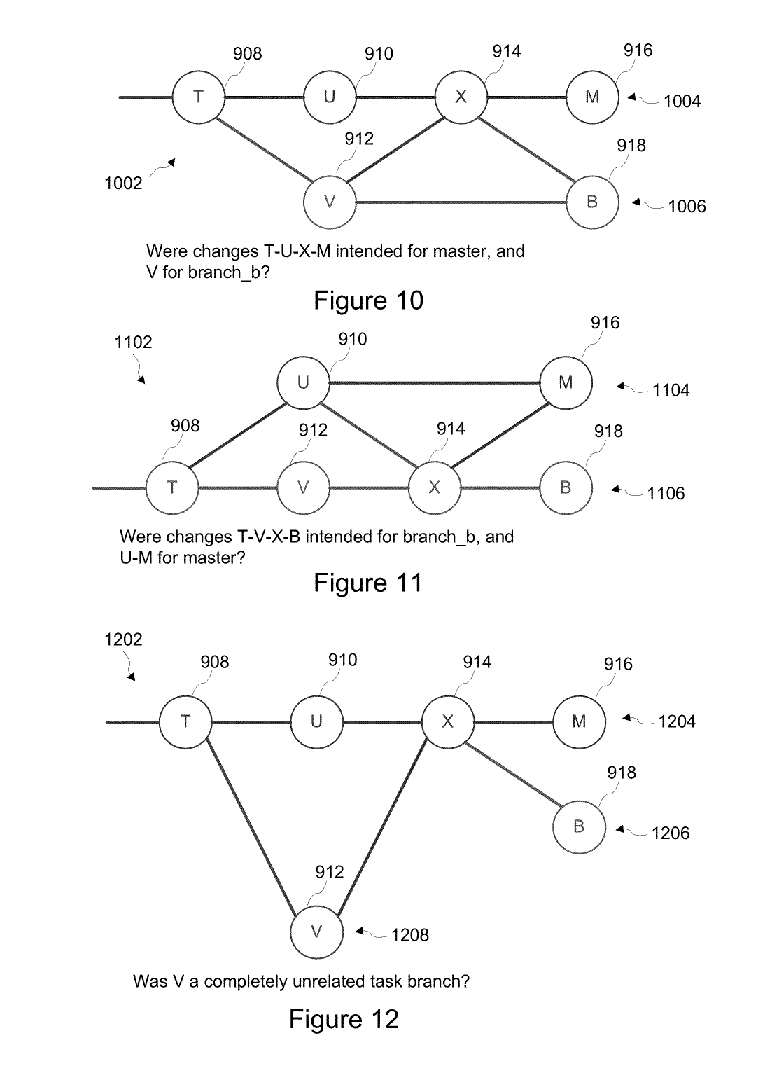

The system is configured to translate an ambiguous branched workspace history, such as a Git commit history, to a branched depot hierarchy according to an embodiment. FIG. 9 illustrates a branched workspace history 902, such as a Git commit history including commit T 908, commit U 910, commit V 912, commit X 914, commit M 916, and commit B 918. As illustrated in FIG. 9, the branched workspace history 902 includes a branch master 904 and a branch branch_b 906. Since, commit T 908 could be produced by several different sequences. FIGS. 10-12 illustrate potential outcomes from a system according to an embodiment that converts a branched workspace history 902 as illustrated FIG. 9 into a branched depot hierarchy.

FIG. 10 illustrates a branched depot hierarchy 1002 that could result from the system converting the branched working history 902 illustrated in FIG. 9. As illustrated in FIG. 10, the branched depot hierarchy 1002 includes commit T 908, commit U 910, commit X 914, and commit M 916 in a first branch 1004 and includes commit V 912 and commit B 918 in a second branch 1006. FIG. 11 illustrates a branched depot hierarchy 1102 that could result from the system converting the branched working history 902 illustrated in FIG. 9. As illustrated in FIG. 11, the branched depot hierarchy 1102 includes commit U 910 and commit M 916 in a first branch 1104 and includes commit T 908, commit V 912, commit X 914, and commit B 918 in a second branch 1106. FIG. 12 illustrates a branched depot hierarchy 1202 that could result from the system converting the branched working history 902 illustrated in FIG. 9. As illustrated in FIG. 11, the branched depot hierarchy 1202 includes commit T 908, commit U 910, commit X 914, and commit M 916 in a first branch 1204; includes commit B 918 in a second branch 1206; and includes commit 1208 in a third branch 1208.

For an embodiment, the system cannot reliably deduce the correct branch for each commit when converting from the branched workspace history to a branched depot hierarchy. In such a case, the branch heads, commit M 916 and commit B 918, are guaranteed to be placed on their correct branch of the branched depot hierarchy. For such an embodiment, the system is configured to use push-state consistency markers in changelist descriptions to handle the potential ambiguity.

The system already appends a block of Git data for the branched workspace history to the end of each changelist in the branched depot hierarchy that it creates. The system may include a push-state value so that humans and their scripts can tell whether this is a commit from the middle of a push or the end, for example:
push-state: incomplete this is not the last commit in a pushed sequence of commits.
push-state: complete this is the last commit in a pushed sequence of commits.
   For an embodiment, continuous integration tools, code reviews, and other policies should only apply to commits with push-state: complete.

This marker is valuable even when pushing linear history: even with linear history guaranteeing the correct branch in the branched depot hierarchy for each commit, the pushed sequence may contain typos, missing files, broken builds, and other problems. For embodiments, the system is configured to check the last commit in the push for correctness.

The system according to an embodiment supports an option to store all push-state: incomplete commits in anonymous branches away from the normal Perforce depot hierarchy, an example of a stored record includes:

# The final commit in a git push is guaranteed to be

# on the correct Perforce branch:

Change: 551167

Date: 2013

Client: git-fusion-gf122

User: nathan Status: submitted Description:

Sanity check connection before proceeding.

As with the recent change to p4gf_auth_udpate_authorized_keys.py, perform a simple read operation using the newly established P4 connection to ensure the user is logged in, an example of a related stored record includes:

Imported from Git

Author: Nathan 1352411550-0800

Committer: Nathan 1352411550-0800

sha1: a202b27035b300fe0b2b9b378a4b5cb44897f17f

push-state: complete

# An intermediate commit in a git push is not guaranteed to be

# on the correct Perforce branch:

Change: 551102

Date: 2012/11/07 16:48:24

Client: git-fusion-gf122

User: n Status: submitted Description:

Silently ignore malformed Git Fusion clients.

While scanning for possible branched depot hierarchy clients to delete, ignore those that do not have a valid client view, an example of a related stored record includes:

Imported from Git

Author: Nathan

Committer: Nathan

sha1: 9465c6560a93f4972c92fccbdc74ce9f88c195bb

push-state: incomplete.

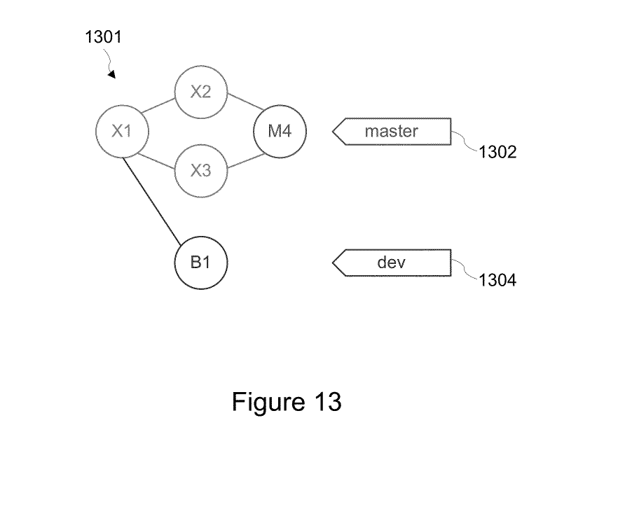

For an embodiment, if you want to share multiple fully populated branches with Git users, populate those branches from within Perforce. It is too easy in Git to create a history that masks the source from which to populate a branch as illustrate in FIG. 13, which includes a branch master 1302 and branch dev 1304.

Embodiments of the system are configured to dig deeply through common Git and Perforce history and determine intentions based on the histories. Other embodiments of the system are not configured to determine an intention.

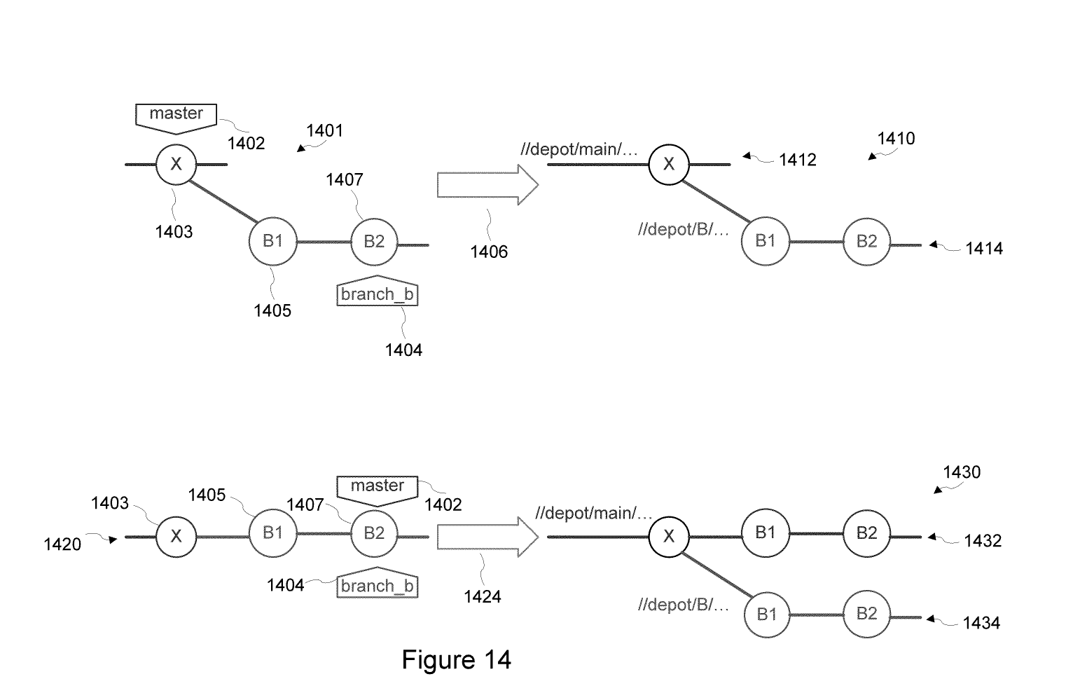

According to an embodiment, the system is configured to translate one commit in a branched workspace history, such as a Git Commit, into multiple changelists in a branched depot hierarchy based on the one commit. It is possible and expected that the system creates multiple changelists in the branched depot hierarchy for a single commit in the branched workspace history. For example, FIG. 14 illustrates a branched workspace history 1401 with branch master 1402 and branch branch_b (task branch) 1404. The system may convert the branched workspace history 1401 by a translation process 1406 that generates a branched depot hierarchy 1410 including a first branch 1412 based on the branch master 1402 including commit X 1403 and a second branch 1414 based the branch_b 1404 including commit B1 1405 and commit B2. Alternatively, the system according to an embodiment, may be configured to merge branch_b 1404 with branch master 1402 into a single branch branched workspace history 1420. The system converts the single branch branched workspace history 1420 by a translation process 1424 that generates a branched depot hierarchy 1430 that includes a first branch 1432 based on the single branch including commit X 1403, commit B1 1405, and commit B2 1407 and a second branch 1434 based on commit B1 1405 and commit B2 of the single branch.

As illustrated in FIG. 14, the branched workspace history 1401 permits a single commit to exist on multiple branches. However, branched depot hierarchies typically do not allow a single changelist to exist on multiple branches.

Repo Refactor

The system, according to an embodiment, is configured to recognize its own lightweight branches and copies their contents to a branched workspace history even across repo refactors. Thus, the system is configured to allow multiple overlapping the branched depot hierarchy repos to share a branched workspace history.

When the system is copying commits from a branched depot hierarchy, such as Perforce, to a branched workspace history, such as Git, the system, according to an embodiment, is configured to include all changes that contribute to any of the named branches in the destination branched workspace history repo. For an embodiment of the system, such as Git Fusion, the system is configured to use an expensive, with regard to the use of resources, p4 command sequence.

Permissions

According to an embodiment, the system is configured to include no new permission options for branch operations. Such an embodiment includes global and per-repo settings to enable branch creation, and where those branches go within a branched depot hierarchy, such as Perforce. To grant or deny individual Git authors or pushers permission to create new branches in the branched depot hierarchy, the system is configured to grant or to deny a user permission to write to the depot path where the system puts new branches translated from the branched workspace history.

Reuse Single Perforce Client

According to an embodiment, the system is configured to use a single Perforce client spec to hold the view mapping between a single view of a branched depot hierarchy and a single branch master from a branched workspace history. The system uses a configuration file to hold multiple view mappings, each mapping a single view of a branched depot hierarchy to a single branch in a branched workspace history. The system is configured to use a single client spec for the branched depot hierarchy. To switch between branches, the system is configured to swap in the appropriate view mapping from the configuration file.

Detect Conflicting Submitted Changelists

For an embodiment, the system is configured to detect conflicting submitted changelists. A single git push can now span multiple branches. The system is configured to reject the push upon detecting any conflicting submitted changelist to any branch involved in this push.

The system, according to an embodiment, is configured to check only the branch being submitted for conflicting changelists in the branched depot hierarchy. Changelists in the branched depot hierarchy submitted to other branches create no conflict. The system is configured to detect those conflicts later if the need to merge or to add more history to those other branches in the branched depot hierarchy.

Detect Deleted Git Branches

A system, according to an embodiment, is configured to detect deleted Git branches. For example, a Git user can send a git push that deletes a Git branch reference from the remote (for example, a server, Git Fusion repo, or other branched depot hierarchy). The system is configured to detect when this happens and delete that branch from the configuration files, such as p4gf_config2 or p4gf_config. For an embodiment, the system does not delete the actual branch in the branched depot hierarchy.

Other features of the system include decouple branch-id and branch-mapping-id. For some embodiments, the system is configured to use 1 to 1 mapping of the branch-id and branch-mapping-id. According to another embodiment, the system is configured to use branch-id and branch-mapping-id that are not a 1 to 1 (1:1) mapping. For such an embodiment, the system is configured to use 1:N mapping of branch-id to branch-mapping-id.

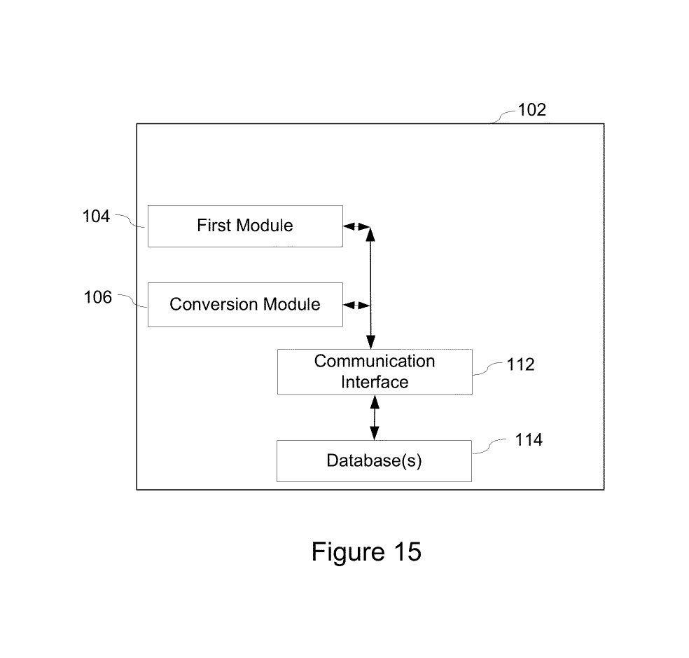

FIG. 15 illustrates a block diagram of an embodiment of a system to associate information to a file according to an embodiment. For an embodiment system 102 may be a computer, a server, a tablet, a smart phone, a user device or other device configured to associate information with a file. The embodiment illustrated in FIG. 15 includes a first module 104. For an embodiment, a first module 104 is coupled with a conversion module 106, and one or more databases 114. The first module 104, according to an embodiment, is configured to perform some or all of methods and processes described herein. A conversion module 106 is configured to for bi-directional conversion of directed acyclic graphs (DAG) and inter-file branching. According to an embodiment, a first module 104 and/or a conversion module is coupled with a database 114 through a communication interface 112.

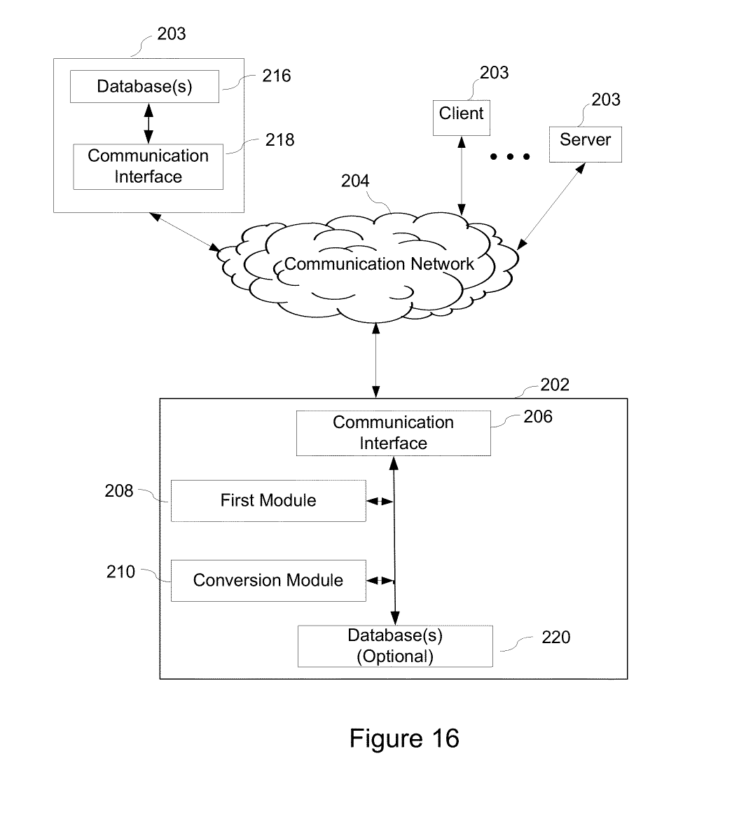

FIG. 16 illustrates a block diagram of a distributed system for bi-directional conversion of directed acyclic graphs (DAG) and inter-file branching. For an embodiment system 202 may be configured to operate as a server in a client-server relationship. For another embodiment system 202 may be configured to operate in a peer-to-peer relationship with one or more peers over a communication network 204. Yet another embodiment includes a system 202 coupled with one or more modules of the system over a communication network 204. A communication network 204 includes, but is not limited to, a wide area network (“WAN”), such as the Internet, a local area network (“LAN”), wireless network, or other type of network. According to embodiments, one or more devices 203 may be in communication with system 202 through a communication network 204. Devices 203 include, but are not limited to, a user device, a server, an external database, a peer, or other device that includes one or more modules configured to performing part or all of methods to associate information with a file or to receive results of a system configured to associate information with a file.

According the embodiment of the system 202 illustrated in FIG. 16, an embodiment of a device 203 that includes one or more a database(s) 216 coupled with a communication interface 218. A database 216 for an embodiment may be configured to store an data, a file, or other information. A communication interface 206, 218, according to an embodiment, is configured to manage communication through a communication network 204 using communication protocols. For some embodiments, a communication interface 206 in a system 202 manages one or more communication sessions between a system 202 and one or more devices 203. A communication interface 206, 218 may also convert or package data or information into the appropriate communication protocol depending on the protocol used by a device 203. According to some embodiments, a communication interface 206, 218 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

The embodiment of a system 202 as illustrated in FIG. 16, in addition to a communication interface 206, includes a first module 208, a conversion module 210, and optionally one or more databases 220. These modules are coupled with each other and configured for bi-directional conversion of directed acyclic graphs (DAG) and inter-file branching using similar techniques as those described herein.

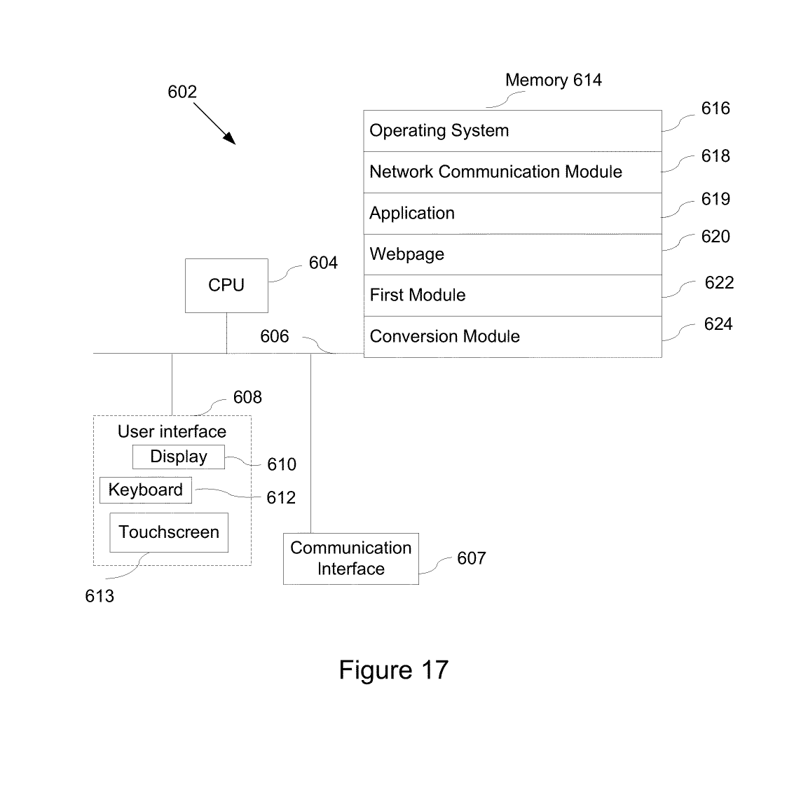

FIG. 17 illustrates an embodiment of system 602 that may be implemented as a client, server, a peer or other device that implements the methods described herein. The system 602, according to an embodiment, includes one or more processing units (CPUs) 604, one or more network or other communication interfaces 607, memory 614, and one or more communication buses 606 for interconnecting these components. The system 602 may optionally include a user interface 608 comprising a display device 610, a keyboard 612, touchscreen 613, and/or other input/output devices. Memory 614 may include high speed random access memory and may also include non-volatile memory, such as one or more magnetic or optical storage disks. The memory 614 may include mass storage that is remotely located from CPUs 604. Moreover, memory 614, or alternatively one or more storage devices (e.g., one or more nonvolatile storage devices) within memory 614, includes a computer readable storage medium. The memory 614 may store the following elements, or a subset or superset of such elements:

an operating system 616 that includes procedures for handling various basic system services and for performing hardware dependent tasks;

a network communication module 618 (or instructions) that is used for connecting the system 602 to other computers, clients, peers, systems or devices via the one or more communication network interfaces 607 and one or more communication networks, such as the Internet, other wide area networks, local area networks, metropolitan area networks, and other type of networks;

an application 619 including, but not limited to, a web browser, a document viewer or other application for viewing information;

a webpage 620 for indicating results, status of the method, or providing an interface for user feedback for the method as described herein;

a first module determination module 622 (or instructions) for performing one or more aspects of methods described herein; and

a conversion module 624 (or instructions) for bi-directional conversion of directed acyclic graphs (DAG) and inter-file branching as described herein.

Although FIG. 17 illustrates system 602 as a computer that could be a client and/or a server system, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 17 could be implemented on a single server or client and single items could be implemented by one or more servers or clients. The actual number of servers, client, or modules used to implement a system 602 and how features are allocated among them will vary from one implementation to another, and may depend in part on the amount of data traffic that the system must handle during peak usage periods as well as during average usage periods. In addition, some modules or functions of modules illustrated in FIG. 6 may be implemented on one or more systems remotely located from other systems that implement other modules or functions of modules illustrated in FIG. 17.

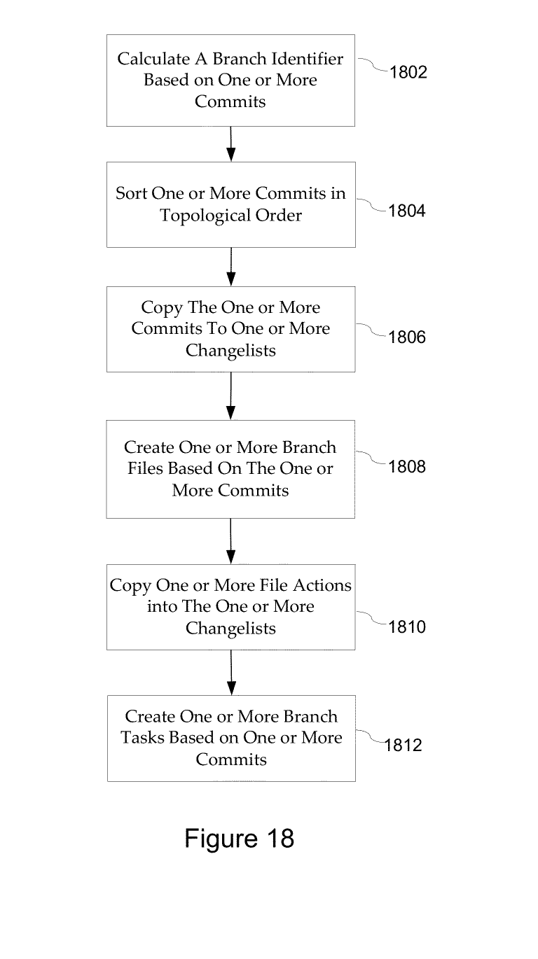

FIG. 18 illustrates a process for generating a branched depot hierarchy based on a branched workspace history according to an embodiment. At step 1802, the process calculates a branch identifier based on one or more commits using techniques including those described herein. At step 1804, the process sorts one or more commits in topological order using techniques including those described herein. At step 1806, the process copies the one or more commits to one or more changelists using techniques including those described herein. At step 1808, the process creates one or more a branch files based on the one or more commits using techniques including those described herein. At step 1810, the process copies one or more file actions into the one or more changelists using techniques including those described herein. At step 1812, the process creates one or more branch tasks based on one or more commits using techniques including those described herein. According to an embodiment, some or all of the steps of the process are recursively reiterated to generate a branched depot hierarchy based on a branched workspace history using techniques including those described herein.

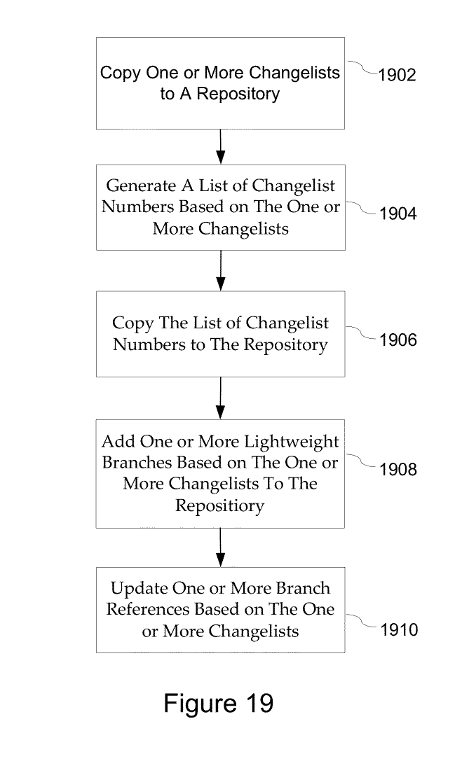

FIG. 19 illustrates a process for generating a branched workspace history based on a branched depot hierarchy according to an embodiment. At step 1902, the process copies one or more changelists to a repository for a branched workspace history using techniques including those described herein. At step 1904, the process generates a list of changelist numbers based on the one or more changelists using techniques including those described herein. At step 1906, the process copies the list of changelist numbers to the repository using techniques including those described herein. At step 1908, the process adds one or more lightweight branches based on the one or more changelists to the repository using techniques including those described herein. At step 1910, the process updates one or more branch references based on the one or more changelists using techniques including those described herein. According to an embodiment, some or all of the steps of the process are recursively reiterated to generate a branched workspace history based on a branched depot hierarchy using techniques including those described herein.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system for bi-directional conversion of directed acyclic graphs and inter-file branching comprising:
memory;
one or more processors; and
one or more modules stored in memory and configured for execution by the one or more processors, the modules comprising:
a conversion module configured to convert between a directed acyclic graph branch and an inter-file branch.

2. The system of claim 1, wherein said conversion module configured to convert between a directed acyclic graph branch and inter-file branch includes said conversion module being configured to calculate one or more branch identifiers based on one or more commits from said directed acyclic graph branch.

3. The system of claim 1, wherein said conversion module is further configured to receive a packfile based on said directed acyclic graph branch.

4. The system of claim 2, wherein said conversion module configured to calculate one or more branch identifiers based on said one or more commits from said directed acyclic graph includes said conversion module being further configured to iterate over said one or more commits from said directed acyclic graph branch.

5. The system of claim 2, wherein said conversion module configured to convert between a directed acyclic graph branch and inter-file branch includes said conversion module being configured to sort said one or more commits from said directed acyclic graph in a topological order.

6. The system of claim 2, wherein said conversion module configured to convert between a directed acyclic graph branch and inter-file branch includes said conversion module being configured to copy said one or more commits from said directed acyclic graph branch to one or more changelists for said inter-file branch.

7. The system of claim 1, wherein said conversion module configured to convert between a directed acyclic graph branch and inter-file branch includes said conversion module being configured to create a branch file for said inter-file branch based on said directed acyclic graph branch.

8. The system of claim 6, wherein said conversion module configured to copy said one or more commits includes said conversion module being configured to copy one or more file actions for said one or more commits into said one or more changelists.

9. The system of claim 2, wherein said conversion module configured to convert between a directed acyclic graph branch and inter-file branch includes said conversion module being configured to create a branch task based on said directed acyclic graph branch.

10. The system of claim 1, wherein said conversion module configured to convert between a directed acyclic graph branch and inter-file branch includes said conversion module being configured to copy one or more changelists from said inter-file branch to a repository for said directed acyclic graph.

11. The system of claim 10, wherein said conversion module configured to convert between a directed acyclic graph branch and inter-file branch includes said conversion module being configured to generate a list of changelist numbers based on said one or more changelists from said inter-file branch and configured to copy said list of changelist numbers to said repository for said directed acyclic graph.

12. The system of claim 10, wherein said conversion module configured to convert between a directed acyclic graph branch and inter-file branch includes said conversion module being configured to add one or more lightweight branches based on at least one of said one or more changelists from said inter-file branch to said repository for said directed acyclic graph.

13. The system of claim 11, wherein said conversion module configured to convert between a directed acyclic graph branch and inter-file branch includes said conversion module being configured to translate said one or more changelists to one or more commits for said repository for said directed acyclic graph.

14. The system of claim 10, wherein said conversion module configured to convert between a directed acyclic graph branch and inter-file branch includes said conversion module being configured to update one or more branch references for said repository for said directed acyclic graph based on said one or more changelists.

15. A method for bi-directional conversion comprising:
at one or more systems including one or more processors and memory:
generating a first set of one or more commits based on a first set of one or more changelists of a branched depot hierarchy; and
generating a second set of one or more changelists based on a second set of one or more commits of a branched workspace history.

16. The method of claim 15, wherein generating said second set of one or more changelists includes calculating one or more branch identifiers based on said second set of one or more commits.

17. The method of claim 15, wherein generating said second set of one or more changelists includes sorting said second set of one or more commits in a topological order.

18. The method of claim 15, wherein generating said second set of one or more changelists includes copying said second set of one or more commits to said set second set of one or more changelists.

19. The method of claim 15, wherein generating said second set of one or more changelists includes creating a branch file based on said second set of one or more commits.

20. The method of claim 15, wherein generating said second set of one or more changelists includes copying one or more file actions for said one or more commits into said second set of one or more changelists.

21. The method of claim 15, wherein generating said second set of one or more changelists includes creating a branch task based on said second set of one or more commits.

22. The method of claim 15, wherein generating said first set of one or more commits includes copying said first set of one or more changelists to a repository for said first set of one or more commits.

23. The method of claim 22, wherein generating said first set of one or more commits includes generating a list of changelist numbers based on said first set of one or more changelists and copying said list of changelist numbers to said repository.

24. The method of claim 22, wherein generating said first set of one or more commits includes adding one or more lightweight branches based on at least one of said first set of one or more changelists to said repository.

25. The method of claim 15, wherein generating said first set of one or more commits includes updating one or more branch references for said repository based on said first set of one or more changelists.

26. A computer readable storage medium storing one or more programs to be executed by one or more processors for performing a method, the method comprising:
generating a first set of one or more commits based on a first set of one or more changelists of a branched depot hierarchy; and
generating a second set of one or more changelists based on a second set of one or more commits of a branched workspace history.
